(19) United States
(12) Patent Application Publication
(10) Pub. No.: US 2024/0045436 A1
(43) Pub. Date: Feb. 8, 2024

(54) TRANSPORT APPARATUS, TRANSPORT SYSTEM, AND CONTROL METHOD FOR TRANSPORT APPARATUS

(71) Applicant: HITACHI INDUSTRIAL PRODUCTS, LTD., Tokyo (JP)

(72) Inventor: Koichi NAKANO, Tokyo (JP)

(21) Appl. No.: 18/267,135

(22) PCT Filed: Nov. 24, 2021
(86) PCT No.: PCT/JP2021/042901

§ 371 Date: Jun. 14, 2023

(30) Foreign Application Priority Data
Jan. 27, 2021 (JP) 2021-011356

(51) Int. Cl. G05D 1/02; B65G 1/137

(52) U.S. Cl. CPC G05D 1/0223; G05D 1/0214; B65G 1/137; G05D 2201/0216

(57) ABSTRACT

A transport apparatus has a drive unit that loads and moves the article and a control unit that controls the drive unit, and has a movement mode in which the transport apparatus moves straight in one direction and a movement mode in which the transport apparatus rotates to face different directions. The control unit is configured to: accelerate under a first acceleration condition including a first acceleration or a first target speed when the transport apparatus loaded with the article moves in a same movement mode as a movement mode before stoppage among the plurality of movement modes with respect to an acceleration condition when the transport apparatus moves from a stopped state, and perform acceleration under a second acceleration condition including a second acceleration smaller than the first acceleration or a second target speed smaller than the first target speed when the transport apparatus moves in another movement mode.

The present application claims priority to Japanese Patent Application No. 2021-011356 filed on Jan. 27, 2021, the contents of which are incorporated herein by reference.

### TECHNICAL FIELD

The present invention relates to a transport apparatus, a transport system, and a control method for the transport apparatus.

### BACKGROUND ART

In a distribution warehouse, delivered articles are stored, and when an order is received, the corresponding articles are taken out, packed, and then shipped to a customer. A large amount of labor is required to move the article, but labor saving can be achieved by adopting a transport system that conveys the article by an automated guided vehicle.

As an example of the transport system, there is a system in which a transport apparatus having a driving wheel and an auxiliary wheel automatically moves to a position of a designated shelf, mounts the shelf storing an article on a table on the transport apparatus, and then conveys the article to a designated picking station. As a technique related to the transport system, for example, there is a technique described in PTL 1.

### CITATION LIST

### Patent Literature

PTL 1: JP 2020-83548 A

### SUMMARY OF INVENTION

### Technical Problem

The transport apparatus automatically moves on the floor surface in the warehouse by combining, for example, a turning mode in which a driving wheel coupled to an electric motor is driven by electric power from a battery to turn the transport apparatus itself and a straight traveling mode in which the transport apparatus moves forward.

Here, when the transport apparatus shifts to the straight traveling mode immediately after the turning mode, if the orientation of the auxiliary wheels is in a direction different from the moving direction, friction between the floor surface and the auxiliary wheels increases, and a high load is applied to the auxiliary wheels and the floor surface.

For example, the inventor of the present application has found a problem that the driving force applied to the driving wheel when starting the transport apparatus increases and the load applied to the transport apparatus and the floor surface increases in a case where the transport apparatus is switched to the straight traveling mode and moved after the turning mode as compared with a case where the transport apparatus is moved again in the straight traveling mode after stopping from the straight traveling mode.

Similarly, for example, in a case where the transport apparatus is switched to the turning mode and moved after the straight traveling mode, there is a problem that the driving force applied to the driving wheel when the transport apparatus is turned increases, and the load applied to the transport apparatus and the floor surface increases.

Therefore, there are provided a transport apparatus, a transport system, and a control method for the transport apparatus capable of reducing a load applied to the transport apparatus and a floor surface when the transport apparatus is started after the movement mode of the transport apparatus is switched.

### Solution to Problem

A transport apparatus according to one aspect of the present invention is a transport apparatus that conveys an article, the transport apparatus including: a drive unit that loads and moves the article; and a control unit that controls the drive unit. The transport apparatus is movable in a plurality of movement modes including a movement mode in which the transport apparatus moves straight in a predetermined direction and a movement mode in which the transport apparatus rotates to face different directions. The control unit is configured to control the drive unit to accelerate under a first acceleration condition including a first acceleration or a first target speed when the transport apparatus loaded with the article moves in a same movement mode as a movement mode before stoppage among the plurality of movement modes with respect to an acceleration condition in a case where the transport apparatus moves from a stopped state, and control the drive unit to perform acceleration under a second acceleration condition including a second acceleration smaller than the first acceleration or a second target speed smaller than the first target speed when the transport apparatus moves in a movement mode different from a movement mode before stoppage among the plurality of movement modes.

### Advantageous Effects of Invention

According to the present invention, it is possible to reduce the load applied to the transport apparatus and the floor surface when starting the transport apparatus after the movement mode of the transport apparatus is switched.

The details of at least one implementation of the subject matter disclosed herein are set forth in the accompanying drawings and the description below. Other features, aspects, and advantages of the disclosed subject matter will be apparent from the following disclosure, drawings, and claims.

### BRIEF DESCRIPTION OF DRAWINGS

FIG. 1 is a block diagram illustrating an example of a configuration of a transport system.

FIG. 2 is a perspective view illustrating an example of a transport apparatus and a shelf.

FIG. 3 is a bottom view illustrating an example of the transport apparatus.

FIG. 4 is an explanatory diagram in which the transport apparatus conveys a shelf.

FIG. 5 is a diagram illustrating an example of order information.

FIG. 6 is a diagram illustrating an example of inventory information.

FIG. 7 is a diagram illustrating an example of shelf information.

FIG. 8 is a diagram illustrating an example of floor information.

FIG. 9 is a diagram illustrating an example of map information.

FIG. 10 is a diagram illustrating an example of device information.

FIG. 11 is a flowchart illustrating an example of processing performed by a warehouse control device.

FIG. 12 is a flowchart illustrating an example of processing performed by the transport apparatus.

FIG. 13 is a diagram illustrating an example of a movement pattern of the transport apparatus in which a straight traveling mode and a turning mode are combined.

FIG. 14 is a diagram illustrating an example of a movement pattern of the transport apparatus in which the straight traveling mode and a temporary stop are combined.

FIG. 15 is a perspective view from above illustrating an example of an auxiliary wheel when the auxiliary wheel is switched from the straight traveling mode to the straight traveling mode after turning 90° in the turning mode.

FIG. 16 is a perspective view from above illustrating an example of a trajectory of the auxiliary wheel after turning 90° in the turning mode from the straight traveling mode.

FIG. 17 is a perspective view from above illustrating an example of a trajectory of the auxiliary wheel when the auxiliary wheel starts traveling in the straight traveling mode after turning 90° in the turning mode.

FIG. 18 is a graph illustrating an example of an acceleration switching pattern according to a first embodiment.

FIG. 19 is a graph illustrating an example of a switching pattern between acceleration and a target speed according to a second embodiment.

FIG. 20 is a graph illustrating an example of an acceleration switching pattern according to a third embodiment.

### DESCRIPTION OF EMBODIMENTS

Hereinafter, embodiments of the invention will be described based on the accompanying drawings.

### First Embodiment

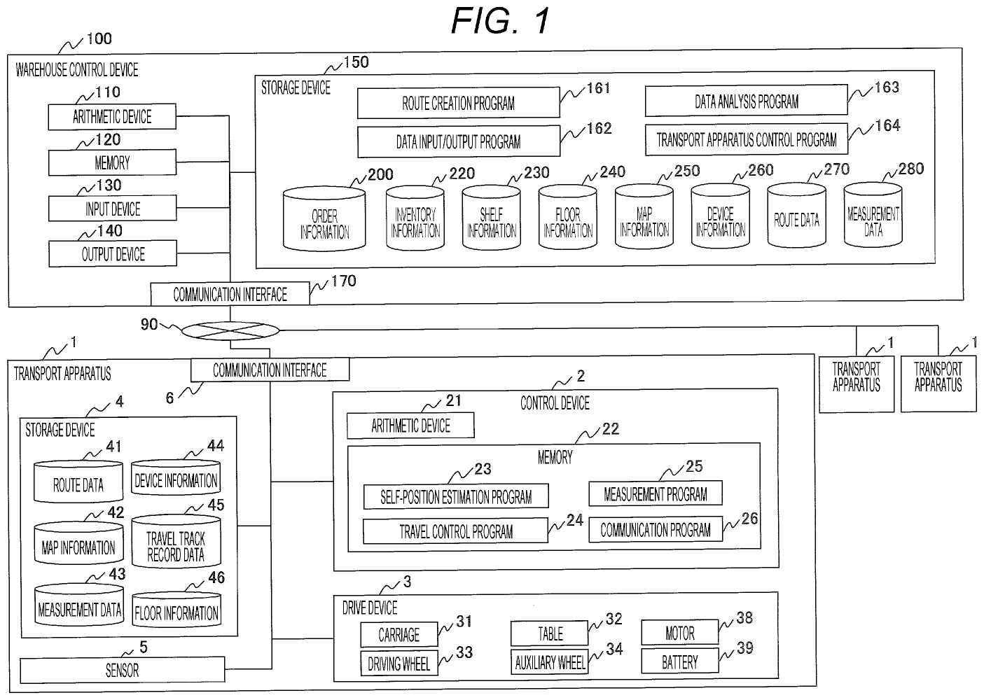

FIG. 1 is a block diagram illustrating an example of a configuration of a transport system according to a first embodiment. The transport system of the present embodiment includes a warehouse control device 100, a network 90, and a plurality of transport apparatuses 1 connected to the warehouse control device 100 via the network 90. For example, an example will be described in which the warehouse control device 100 transmits a transport command designating a shelf to be conveyed by the transport apparatus 1 and a picking station as a transport destination to the transport apparatus 1, and causes the transport apparatus 1 to automatically convey the shelf to the picking station.

The warehouse control device 100 is a computer including an arithmetic device 110, a memory 120, an input device 130, an output device 140, a storage device 150, and a communication interface 170.

The storage device 150 has a nonvolatile storage medium, and stores a program executed by the arithmetic device 110 and data used by the program. As an example of the program, a route creation program 161, a data input/output program 162, a data analysis program 163, and a transport apparatus control program 164 are stored in the storage device 150, and the arithmetic device 110 loads and executes a necessary program in the memory 120.

In addition, as an example of data stored in the storage device 150, order information 200, inventory information 220, shelf information 230, floor information 240, map information 250, device information 260, route data 270, and measurement data 280 are stored.

The route creation program 161 calculates a route on which the transport apparatus 1 moves. The route creation program 161 calculates a route on which the transport apparatus 1 moves from, for example, the position of an article (or product) to be picked, the position of a picking station of a destination, and the like. The data input/output program 162 receives order information, receives sensor data from the transport apparatus 1, and the like, and outputs information on an article to be picked.

When the sensor data is an image or a video of the floor, the data analysis program 163 analyzes the state of the floor of the route along which the transport apparatus 1 has moved, and updates the floor information 240. The transport apparatus control program 164 commands a shelf, an article to be conveyed and a transport destination to the available transport apparatus 1 based on the route calculated by the route creation program 161, the floor information 240, the state of the transport apparatus 1, and the like.

The order information 200 is information on an order for requesting shipment of an article, and stores information on an article to be picked. The inventory information 220 stores information on a shelf on which an article is arranged, and information on an arrangement position in the shelf, a quantity, a weight, and the like regarding the inventory of the article.

The shelf information 230 stores information such as the position and weight of the shelf. The floor information 240 stores information indicating a state of the floor for each area of the floor. The map information 250 stores map information in the warehouse. The device information 260 stores identification information (identifier), a position, an operating state, and the like of each of the transport apparatuses 1. The route data 270 stores information on a route for each transport apparatus 1. The measurement data 280 stores sensor data, position information, and the like received from each transport apparatus 1.

The input device 130 includes a keyboard, a mouse, a touch panel, or the like. The output device 140 includes a display or the like. The communication interface 170 communicates with the transport apparatus 1 and other computers via the network 90.

The transport apparatus 1 automatically conveys a shelf on which an article is mounted in response to a command from the warehouse control device 100. The transport apparatus 1 is an automatic transport apparatus including a control device (control unit) 2, a storage device 4, a drive device (drive unit) 3, a sensor 5, and a communication interface 6.

The control device 2 includes an arithmetic device 21 and a memory 22. A self-position estimation program 23, a travel control program 24, a measurement program 25, and a communication program 26 are loaded into the memory 22 and executed by the arithmetic device 21. The arithmetic device 21 includes a microcomputer or a processor.

The self-position estimation program 23 calculates the position of the transport apparatus 1 based on the sensor data (for example, image data) acquired from the sensor 5. The travel control program 24 controls the drive device 3 based on the current position of the transport apparatus 1 and the route data received from the warehouse control device 100.

The measurement program 25 acquires sensor data from the sensor 5 and outputs the sensor data to the warehouse control device 100. The communication program 26 communicates with the warehouse control device 100 via the network 90.

The storage device 4 includes a nonvolatile storage medium, and stores each program and data used by each program. Examples of the data include route data 41, map information 42, measurement data 43, device information 44, travel track record data 45, and floor information 46.

The route data 41 stores route data received from the warehouse control device 100. The map information 42 stores the map information 250 received from the warehouse control device 100. The measurement data 43 stores sensor data acquired by the sensor 5.

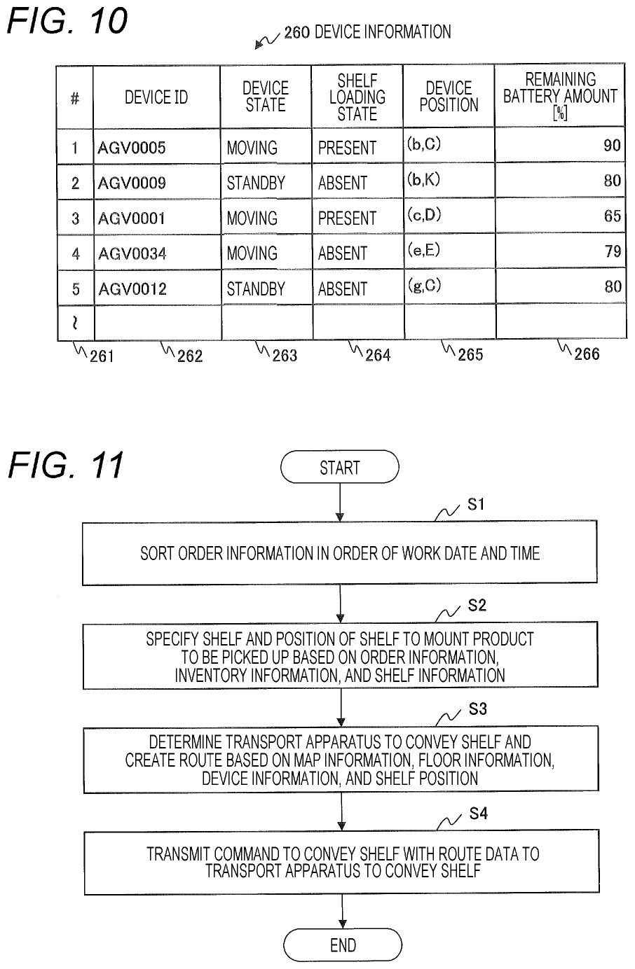

The device information 44 stores an identifier (device ID) of the transport apparatus 1, a state of the device, information regarding the presence or absence of loading of a shelf, a position of the device, a remaining battery amount, and the like. For example, the device information 44 may be information equivalent to the information regarding the transport apparatus 1 in the device information 260 (FIG. 10). The travel track record data 45 stores a history of a route on which the transport apparatus 1 has moved, a state (vibration) of the floor surface for each area, a movement mode, and the like.

The floor information 46 stores the floor information 240 received from the warehouse control device 100. The control device 2 can determine an acceleration condition of the transport apparatus 1 based on the information on the state of the floor surface on which the transport apparatus 1 moves.

The drive device 3 includes a carriage 31, a driving wheel 33, a table 32, an auxiliary wheel (caster) 34, a motor 38 as a power source for driving the driving wheel 33 and the table 32, and a battery 39 for supplying electric power to the motor 38. The configuration of the drive device 3 will be described later. The driving wheel 33 and the motor 38 that drives the table 32 can be configured as independent motors.

The sensor 5 includes a camera that captures an image of the floor, an acceleration sensor that detects vibration, and the like. When position information such as a mark and route information are provided on the floor surface, the current position can be specified by photographing the floor surface with a camera as the sensor 5 and identifying the mark with the self-position estimation program 23. The acceleration sensor as the sensor 5 can detect vibration (acceleration) of the transport apparatus 1, and the measurement program 25 can notify the warehouse control device 100 of the magnitude of the vibration and the like as the state of the floor surface.

The arithmetic device 21 operates as a functional unit which provides a predetermined function by performing processing according to the program of each functional unit. For example, the arithmetic device 21 functions as a travel control unit by executing processing according to the travel control program 24. The other programs are performed similarly. Further, the arithmetic device 21 operates also as a functional unit which provides each function of the plurality of processing performed by the programs.

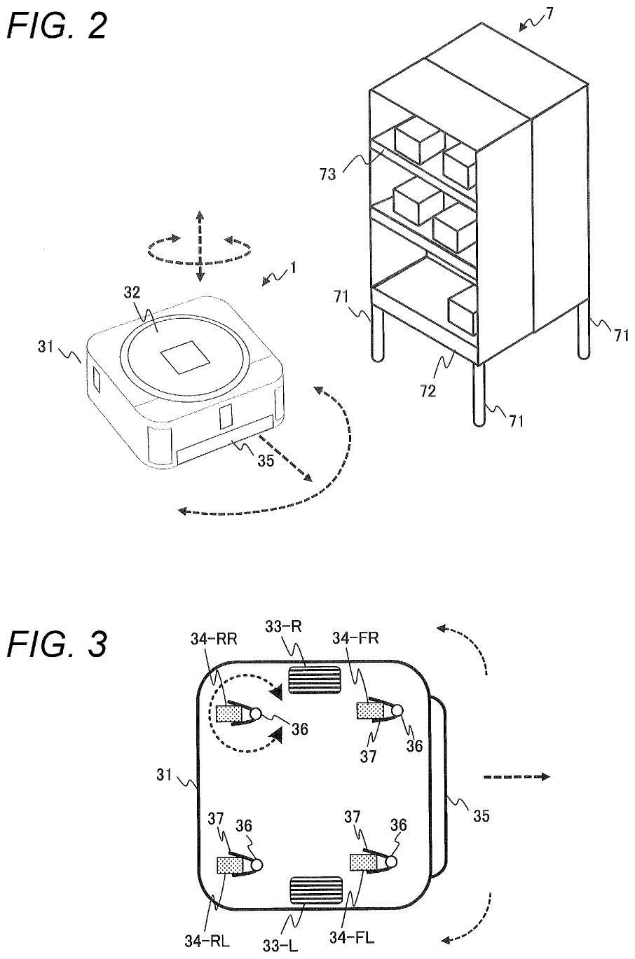

FIG. 2 is a perspective view illustrating an example of the transport apparatus 1 and the shelf 7. The transport apparatus 1 is an automatic traveling device including the rectangular parallelepiped carriage 31 capable of moving straight and turning, and the table 32 that is disposed on an upper surface of the carriage 31 and capable of moving up and down and turning. The transport apparatus 1 may be, for example, an automated guided vehicle (AGV) or an autonomous mobile robot (AMR). A bumper 35 is disposed on a side of the carriage 31 in the forward direction.

The shelf 7 for storing articles (or products) is formed of a rectangular parallelepiped having a pair of openings on a side surface, and a bottom plate 72 supported by the legs 71 at a predetermined height from a floor surface and one or more shelf plates 73 on which articles are placed are arranged.

The transport apparatus 1 moves the carriage 31 below the bottom plate 72 of the shelf 7 while lowering the table 32, and then raises the table 32 to lift the shelf 7. The transport apparatus 1 conveys the shelf 7 by causing the carriage 31 to travel while lifting the shelf 7 with the table 32.

The table 32 is turnable with respect to the carriage 31, and when the carriage 31 turns on the floor surface, the table 32 is relatively rotated with respect to the carriage 31, so that the direction of movement of the carriage 31 can be changed while the direction of the shelf 7 is maintained.

In the example shown, since the shelf 7 has two opening surfaces, different openings can be provided to the picking station by turning the table 32 by 180°. Note that the configuration of the shelf 7 is not limited to the illustrated example, and it is sufficient that the shelf 7 has the bottom plate 72 that can be lifted up by the table 32, such as a box or a pallet on which a hanger is installed or a four-sided opening is provided.

FIG. 3 is a bottom view illustrating an example of the transport apparatus 1. The bottom surface of the carriage 31 has the bumper 35 side as the front, and driving wheels 33-L and 33-R are arranged on the left and right in the middle of the bottom surface in the front-rear direction to cause the carriage 31 to travel straight or turn. In the following description, when the left and right of the driving wheel are not specified, reference numeral “33” in which “−”and subsequent characters are omitted is used. The same applies to reference numerals of other components.

Auxiliary wheels 34-FL, 34-RL, 34-FR, and 34-RR are disposed in front of and behind the driving wheels 33-L and 33-R, respectively, to support the carriage 31. Each auxiliary wheel 34 is supported via a holder 37 so as to be turnable about a shaft 36 provided on the bottom surface of the carriage 31. Each auxiliary wheel 34 is rotatably supported on the floor surface by a shaft (not illustrated) supported by the holder 37.

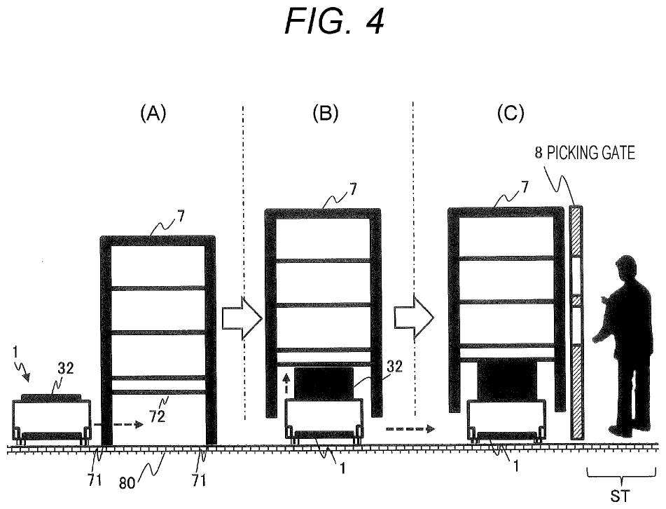

FIG. 4 is an explanatory diagram in which the transport apparatus 1 conveys the shelf 7. The transport apparatus 1 moves the carriage 31 below the bottom plate 72 of the shelf 7 and between the legs 71 and 71 in a state where the table 32 is lowered (A). Next, the transport apparatus 1 stops the carriage 31 with the table 32 facing the bottom plate 72, and then raises the table 32 to lift the bottom plate 72 to a predetermined height (B). The height at which the shelf 7 is lifted may be any height as long as the carriage 31 can travel without the leg 71 of the shelf 7 contacting the floor 80.

In a state where the shelf 7 is lifted up by the table 32, the transport apparatus 1 moves to a picking station ST as a transport destination by combining the turning and the straight movement of the carriage 31, and turns the table 32 or the carriage 31 such that the opening of the shelf 7 faces a picking gate 8. Then, the transport apparatus 1 causes the worker to perform the picking work in a stopped state (C).

In the picking gate 8, the worker takes out the article to be shipped from the shelf 7 and performs picking work of distributing the article to the sorting shelf. When the picking work is completed, the transport apparatus 1 moves to a predetermined storage place where the shelf 7 is stored, and lowers the shelf 7 at the storage place. After unloading the shelf 7, the carriage 31 is moved to a predetermined standby position and waits for the next transport work.

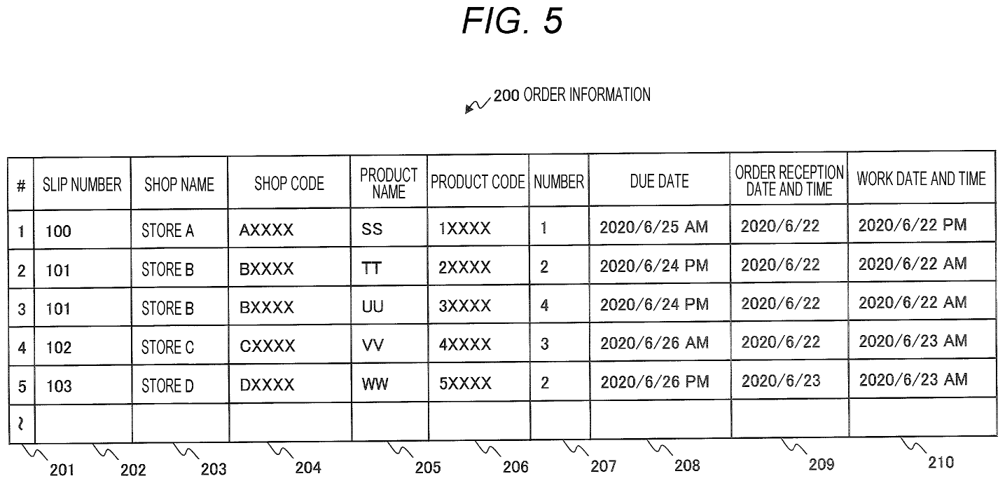

FIG. 5 is a diagram illustrating an example of the order information 200. The order information 200 includes a serial number 201, a slip number 202, a shop name 203, a shop code 204, a product name 205, a product code 206, a number 207, a due date 208, an order reception date and time 209, and a work date and time 210 in one record.

The serial number 201 is a unique number assigned by the warehouse control device 100. The slip number 202 is a number assigned by the warehouse control device 100 for each order. The shop name 203 indicates a shipping destination of the article.

In the present embodiment, an example in which different serial numbers 201 are assigned in a case where the product name 205 and the product code 206 are different even if the slip number 202 is the same will be described. This is because, when the product name 205 and the product code 206 are different, there is a possibility that the shelves 7 on which the respective products are stored are different.

The number 207 indicates the quantity of ordered products specified by the product name 205 and the product code 206 in the slip number 202 of the record. The work date and time 210 stores a scheduled date and time when the picking work is performed for the product name 205 of the slip number 202. In addition to the due date 208, the work date and time 210 is determined based on a request of a customer (request for early shipment before delivery, etc.) or a status of a warehouse (for example, in a case where there is a circumstance that the product is desired to be shipped early). The work date and time 210 may be determined by other software (for example, a warehouse management system (WMS)) cooperating with the warehouse control device 100 or the like, or may be set by the user.

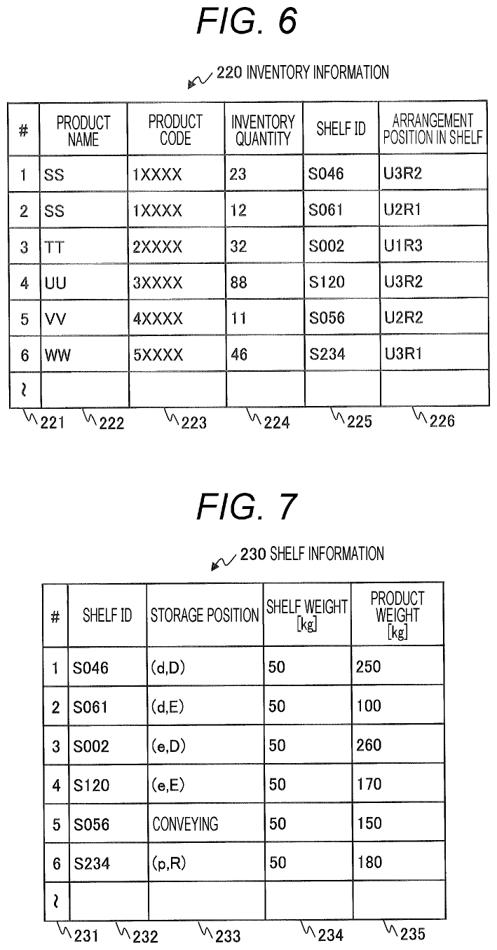

FIG. 6 is a diagram illustrating an example of the inventory information 220. The inventory information 220 includes a serial number 221, a product name 222, a product code 223, an inventory quantity 224, a shelf ID 225, and an arrangement position 226 in the shelf in one record.

The shelf ID 225 stores an identifier of the shelf 7 in which the product is stored. The arrangement position 226 in the shelf stores information used when a person or a robot picks in, for example, the picking station ST. For example, in a record described as “U3R2”, the arrangement position 226 in the shelf indicates that the target product is disposed in “the third row from the top (U) and the second row from the right (R)” on the shelf 7.

FIG. 7 is a diagram illustrating an example of the shelf information 230. The shelf information 230 includes a serial number 231, a shelf ID 232, a storage position 233, a shelf weight 234, and a product weight 235 in one record.

The shelf ID 232 stores a unique identifier assigned to each shelf 7. For example, an identifier given by the warehouse control device 100 may be stored as the shelf ID 232. The storage position 233 stores information on a position where the shelf 7 is stored, and for example, coordinates of the map information 250 are stored. When the shelf 7 is being conveyed, “conveying” is stored in the storage position 233.

The shelf weight 234 stores the weight of the shelf 7 itself, and the product weight 235 stores the weight of an article (a product, a container for storing a product, or the like) mounted on the shelf 7. The weight of the transport object (shelf+product) conveyed by the transport apparatus 1 is at least the sum of “shelf weight” and “product weight”.

For example, in the inventory information 220 and the like of FIG. 6, the weight of each product, the inventory quantity, and the like may be recorded, and for example, the weight of the transport object (shelf+product) may be obtained by calculation. Note that, in a case where the “weight” is obtained by calculation, if the weight falls within the allowable range of the error between the actual weight of the transport object and the calculation value, it is also possible to exclude some of the weights of the shelf 7 and the products mounted on the shelf 7 from the calculation.

As another example, for example, a weight sensor capable of measuring the “weight of the transport object (shelf+product)” conveyed by the transport apparatus 1 may be mounted, and the weight may be measured when the shelf 7 after completion of picking is returned to the storage position. At this time, the weight measured by the transport apparatus 1 may be received by the warehouse control device 100 and recorded as the “weight of the transport object (shelf+product)” in the shelf information 230.

The warehouse control device 100 specifies the storage position 233 of the shelf 7 using the information of the shelf ID 225 acquired from the inventory information 220 of FIG. 6 as a key. The warehouse control device 100 calculates the movement route of the transport apparatus 1 from, for example, the position of the transport apparatus 1 close to the storage position of the shelf 7, the storage position 233 of the shelf 7, and information of the picking station ST to be the transport destination of the shelf 7 among the devices in the “standby” state in the transport apparatus 1.

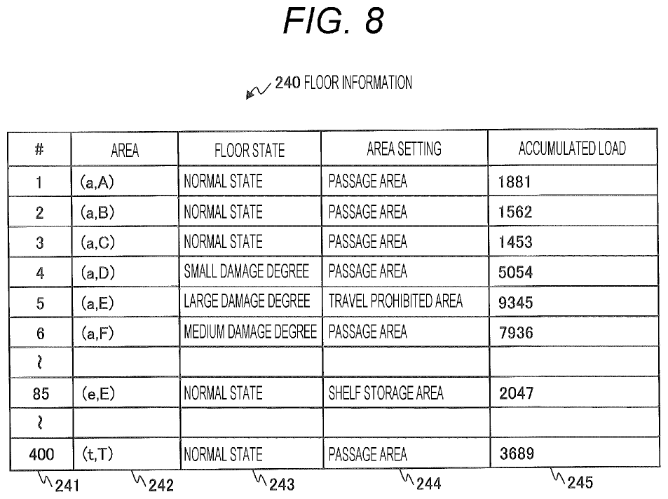

FIG. 8 is a diagram illustrating an example of the floor information 240. The floor information 240 includes a serial number 241, an area 242, a floor state 243, an area setting 244, and an accumulated load 245 in one record.

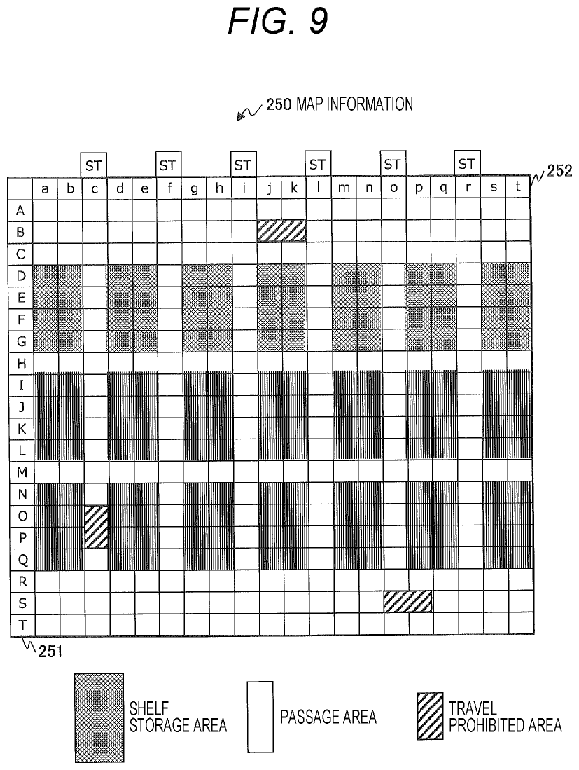

The area 242 manages the state of the floor of the warehouse in units of areas (sections), and stores information for identifying each area. For example, (a, A) of serial number 241=1 indicates an upper left address (a, A) in map information 250 of FIG. 9.

The floor state 243 stores information indicating the floor state, particularly the damage level. For example, it may be classified into levels such as “normal state”, “small damage degree”, “medium damage degree”, and “large damage degree”. The floor state 243 may be, for example, “normal state”, “small damage degree”, “medium damage degree” indicating that the vehicle can travel, and “large damage degree” indicating that the vehicle cannot travel (travel prohibited).

When the area setting 244 is “passage area”, it indicates that the transport apparatus 1 can travel and the shelf 7 can be conveyed. When the area setting 244 is “shelf storage area”, it indicates an area where the shelf 7 to be conveyed by the transport apparatus 1 is placed or an area secured as a location for placing the shelf 7.

The transport apparatus 1 in a state of not conveying the shelf 7 can pass under the shelf 7 and thus can travel, but the transport apparatus 1 in a state of conveying the shelf 7 does not travel in an area where another shelf 7 is present in order to avoid collision of the shelf 7.

When the area setting 244 is “travel prohibited area”, the travel of the transport apparatus 1 is restricted in the area. For example, an area with “large damage degree” may be a “travel prohibited area”. In addition, an area where an obstacle that hinders traveling is detected, an area where a person or another device works, or the like may be set as the “travel prohibited area”. One that satisfies a predetermined condition may be automatically set as the “travel prohibited area”, or the user may set the “travel prohibited area”. The accumulated load 245 is a value obtained by accumulating the load applied to the floor of the area from the transport apparatus 1. Examples of the load include a load when the transport apparatus 1 passes (the number of times of passage, the weight when passing, and the like), a load when the transport apparatus turns (the number of rotations and the weight when rotating), and a load when the transport apparatus 1 accelerates or decelerates (the number of times of acceleration, the weight at the time of acceleration, the number of times of deceleration, the weight at the time of deceleration, and the like).

The accumulated load 245 may be a value calculated based on some or all information of these loads. For example, it may be a total weight value obtained by accumulating weights at the time of passing.

FIG. 9 is a diagram illustrating an example of the map information 250. The map information 250 is information indicating the position of an “area” designated by a row number 251 and a column number 252. Each area is a rectangular area, and is set to any one of “passage area”, “shelf storage area”, and “travel prohibited area” according to the area setting 244 of the floor information 240 described above.

FIG. 10 is a diagram illustrating an example of the device information 260. The device information 260 includes a serial number 261, a device ID 262, a device state 263, the shelf loading state 264, a device position 265, and a remaining battery amount 266 in one record.

The device ID 262 stores a unique identifier assigned to each transport apparatus 1. The device state 263 stores information on the state of each transport apparatus 1. As the state, for example, states such as “standby”, “moving”, “charging”, and “failure” are input. The shelf loading state 264 is information regarding the presence or absence of loading of the shelf 7 in the transport apparatus 1. The shelf loading state 264 is information indicating whether the shelf 7 is loaded on the table 32 of the transport apparatus 1.

Note that, for example, when the warehouse control device 100 selects the transport apparatus 1 that processes (instructs transport) a certain transport task, the transport task can be selected based on transport efficiency or the like. For example, even the transport apparatus 1 in the “moving” state may be selected when the current task is completed early and the next transport task (the certain transport task described above) can be processed earlier than the others.

The device position 265 stores information on the position of each transport apparatus 1. For example, the transport apparatus 1 reads information (for example, a mark) given to a predetermined position on a floor surface of each area by a sensor (camera). The information read by the transport apparatus 1 includes information on the position of the area, and the self-position can be specified. Note that the method for specifying the self-position may be another method.

The remaining battery amount 266 is information related to the remaining amount of the battery 39 of each transport apparatus 1. The transport apparatus 1 may charge the charging station when the remaining battery amount 266 becomes equal to or less than a predetermined remaining battery amount.

However, the schedule related to charging may be determined according to the availability (reservation status) of the charging station, the transport schedule, the remaining battery amount of each transport apparatus 1, and the like. For example, when a large number of transport apparatuses 1 perform charging at the same timing, there is a possibility that the charging station becomes congested and a waiting for charging may occur. Therefore, a schedule considering transport efficiency is desirable.

FIG. 11 is a flowchart illustrating an example of processing performed by the warehouse control device 100. This processing is executed at a predetermined timing such as a predetermined cycle or a timing when an order is received.

In the warehouse control device 100, the route creation program 161 sorts the order information 200 in ascending order of the work date and time 210, and performs the following processing in order from the head record (S1). The route creation program 161 selects the order information 200, searches the inventory information 220 from the product code 206, and determines the presence or absence of the inventory quantity 224. When there is stock, the route creation program 161 acquires the shelf ID 225 and the arrangement position 226 in the shelf, and searches the shelf information 230 to specify the storage position 233 (S2).

The route creation program 161 refers to the map information 250, the area setting 244 of the floor information 240, and the device information 260 to select, from the device information 260, the transport apparatus 1 having the maximum transport efficiency from the storage position 233 to the picking station ST as described above. Note that the picking station ST of the transport destination may be set in advance according to the shipping destination (shop name 203), or may be set in advance according to the product on which the picking work is performed or the type of the product.

Then, the route creation program 161 calculates the transport route of the transport apparatus 1 from the map information 250, the area setting 244 of the floor information 240, the storage position 233, and the information of the picking station ST (S3). Note that a widely-known or well-known method can be adopted for calculation of the transport route.

Next, the transport apparatus control program 164 transmits a command to convey the determined shelf 7 with the calculated route information to the determined transport apparatus 1 (S4). The transport apparatus 1 having received the transport command from the warehouse control device 100 travels along the received route, mounts the designated shelf 7, and conveys the shelf 7 to a predetermined picking station ST.

After the picking work is completed, the transport apparatus 1 carries the shelf 7 to the storage place, and lowers the shelf 7 to the floor 80. Thereafter, the transport apparatus 1 moves to a predetermined standby place and ends the transport task.

Note that the position where the transport apparatus 1 returns the shelf 7 may be returned to the original storage place, or may be stored at different positions based on the frequency of use of the shelf 7 or the like. For example, if the shelf 7 has a high frequency of use, the transport apparatus 1 may place the shelf 7 near the picking station ST.

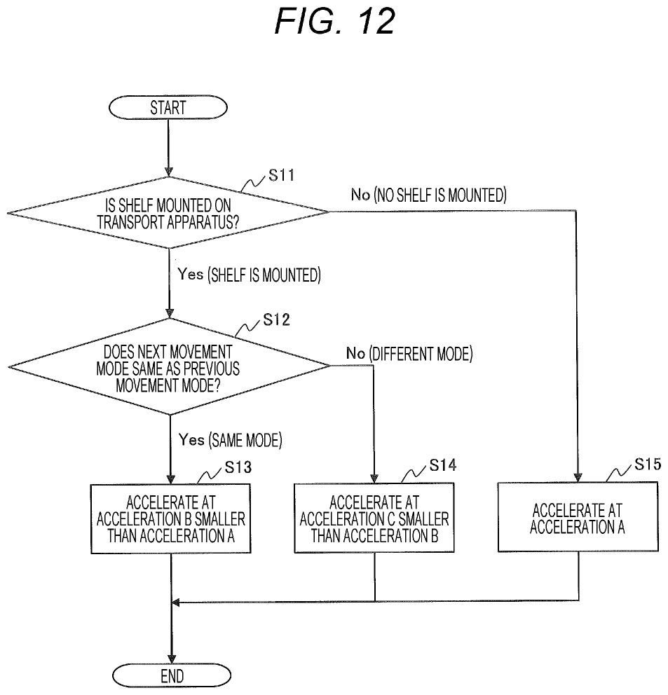

FIG. 12 is a flowchart illustrating an example of processing performed by the transport apparatus 1. This processing shows an example in which the control device 2 executes the travel control program 24 to perform acceleration control, and is executed when the transport apparatus 1 starts after stopping.

The control device 2 of the transport apparatus 1 switches between two movement modes (or transport modes) of a straight traveling mode in which the driving wheels 33-L and 33-R are driven at a constant speed and a turning mode in which the driving wheels 33-L and 33-R are rotated in the reverse directions to move the carriage 31. In the turning mode, the direction of the shelf 7 can be maintained by turning the table 32 in the reverse direction to the turning of the carriage 31. When the driving wheels 33-L and 33-R are driven at different speeds in the same rotation direction, the carriage 31 can be turned while traveling.

The turning mode for driving the driving wheels 33-L and 33-R in the reverse direction is a spin turn, and for example, the driving wheels turn about the center of the bottom surface of the carriage 31 as an axis. Hereinafter, the spin turn is simply referred to as turning.

The control device 2 determines the movement mode and controls the driving wheel 33 based on the route data 41 received from the warehouse control device 100 and the current position of the carriage 31 detected by the self-position estimation program 23.

The control device 2 determines whether the shelf 7 is loaded on the table 32 (S11). Regarding the presence or absence of the shelf 7, for example, a sensor for detecting an article such as the shelf 7 is provided on the table 32, and if the output of the sensor satisfies a predetermined condition, the control device 2 determines that the shelf 7 is loaded on the table 32 and proceeds to step S12. On the other hand, when the predetermined condition is not satisfied, the control device 2 determines that the table 32 does not load the shelf 7 and proceeds to step S15.

In step S12, the control device 2 determines whether the previous movement mode and the next movement mode are the same. This determination is made by the control device 2 referring to the travel track record data 45 to acquire the previous movement mode and comparing the next movement mode determined based on the route data 41. When the previous movement mode and the next movement mode are the same, the process proceeds to step S13, and when the previous movement mode and the next movement mode are different, the process proceeds to step S14.

In a case where the shelf 7 is not loaded in step S15, the control device 2 selects the maximum acceleration A to drive the driving wheel 33 or the table 32. When the shelf 7 is loaded and the movement mode is the same as the previous mode, the control device 2 selects the acceleration B smaller than the acceleration A in step S13 to drive the driving wheel 33 or the table 32. When the shelf 7 is loaded and the movement mode is different from the previous mode, the control device 2 selects the minimum acceleration C smaller than the acceleration B in step S14 to drive the driving wheel 33 or the table 32.

Here, the “maximum acceleration A” indicates that the acceleration A is the maximum acceleration among the acceleration A, the acceleration B, and the acceleration C. Similarly, the “minimum acceleration C” indicates that the acceleration C is the minimum acceleration among the acceleration A, the acceleration B, and the acceleration C.

As the accelerations A to C, acceleration at the time of straight traveling and angular acceleration at the time of turning are set in advance. For example, a predetermined acceleration A1, a predetermined acceleration B1, and a predetermined acceleration C1 may be set in advance as the acceleration A, the acceleration B, and the acceleration C at the time of traveling straight. In addition, a predetermined angular acceleration A2, a predetermined angular acceleration B2, and a predetermined angular acceleration C2 may be set in advance as the acceleration A, the acceleration B, and the acceleration C at the time of turning. The accelerations (accelerations A1, B1, and C1) at the time of straight traveling and the accelerations (angular accelerations A2, B2, and C2) at the time of turning may be different.

In the above processing, a case where the transport apparatus 1 mainly controls the acceleration is illustrated, and the acceleration is determined according to the movement mode based on the route data received from the warehouse control device 100. Note that the control device 2 may specify the previous movement mode from the route data 41 or from the travel track record data 45. In addition, the acceleration may be determined by determining the presence or absence of loading of the shelf 7 from the route data received by the control device 2 from the warehouse control device 100 or the device information 44 included in the transport apparatus 1.

Although the example in which the transport apparatus 1 controls the acceleration has been described above, the invention is not limited thereto. For example, the warehouse control device 100 can determine the presence or absence of loading of the shelf 7 in the transport apparatus 1 from the route data or the device information 260, determine the acceleration, and command the transport apparatus 1.

When the warehouse control device 100 is the subject of the acceleration control, in step S4 of FIG. 11, for example, information on the acceleration in the movement between the areas can be included in the route data and transmitted to the transport apparatus 1.

The acceleration information is not limited to the acceleration itself, and may be information that can specify the acceleration (examples: acceleration mode A, acceleration mode B, acceleration mode C) or information related to the acceleration (examples: torque and rotational speed of the motor 38 of the drive device, speed at a certain time, and speed at the time of passing through a certain area).

In the above description, the example in which the acceleration is controlled by the transport apparatus 1 has been described, but the present invention is not limited thereto, and the acceleration and the target speed may be controlled as acceleration conditions. For example, the transport apparatus 1 accelerates under a first acceleration condition (first acceleration and first target speed) and moves in a movement mode different from that before stoppage. Thereafter, the transport apparatus 1 may accelerate under a second acceleration condition (second acceleration and second target speed) smaller than the first acceleration condition.

With respect to the acceleration condition, it is not always necessary to change the acceleration. For example, by setting the speed threshold to be small, it is possible to prevent the deviation of the speeds of the left and right wheels from being generated. Therefore, it is possible to prevent a load from being applied to the drive unit and the floor surface in an attempt to forcibly accelerate the vehicle.

In addition, in step S15 in a case where the transport apparatus 1 does not load the shelf 7, the carriage 31 accelerates with the maximum acceleration A, which is because the load of the carriage 31 applied to the floor surface is small in a case where the shelf 7 is not loaded, and thus it is not necessary to accelerate slowly.

However, as another example, in a case where the load on the transport apparatus 1 or the floor surface is high even if the shelf 7 is not loaded (for example, if the floor surface is made of an easily damaged material, or the like), a step of determining “Is next movement mode the same mode as previous movement mode?” may be added, and in a case where this determination is “No” (in a case of a different mode), control may be performed such that “Accelerate at an acceleration smaller than the acceleration A”.

In addition to the above, the acceleration may be controlled according to the degree of damage of the floor state 243 in the floor information 240 illustrated in FIG. 8, the accumulated load 245, and unevenness of the floor surface (seam, step, or the like originally provided as a specification of the floor surface). Specifically, when the degree of damage to the floor surface is large, when the accumulated load is high, or when there is unevenness (seam or step) on the floor surface, the acceleration may be reduced so as to accelerate more slowly than when there is no damage.

In addition, in a case where the load related to the floor surface and the transport apparatus 1 is particularly large, for example, in a case where the transport apparatus 1 on which the shelf 7 is loaded moves in a movement mode different from the previous movement mode, by reducing the acceleration so as to accelerate slowly according to the state of the floor surface, it is expected to operate an efficient transport system in consideration of the load related to the floor surface and the transport apparatus 1 and the transport efficiency.

Alternatively, the acceleration may be determined based on a weight such as a total value of the shelf weight 234 and the product weight 235 in the shelf information 230 of FIG. 7. For example, in a case where the weight is heavy, the acceleration may be controlled to be slower than in a case where the weight is light.

With respect to the acceleration when the transport apparatus 1 not loaded with the shelf 7 moves from a stopped state, the control device 2 may control the drive device 3 to accelerate at the acceleration A (a third acceleration condition including a third acceleration or a third target speed) in a case where the transport apparatus 1 moves in the same movement mode as the movement mode before stoppage among the plurality of movement modes, and may control the drive device 3 to accelerate at the acceleration D (see FIG. 19) smaller than the acceleration A or a fourth acceleration condition including the fourth target speed smaller than the third target speed in a case where the transport apparatus 1 moves in a movement mode different from the movement mode before stoppage among the plurality of movement modes. That is, even when the transport apparatus 1 moves alone regardless of the loading of the shelf 7, it is possible to switch the acceleration condition in different movement modes depending on the situation such as the floor surface.

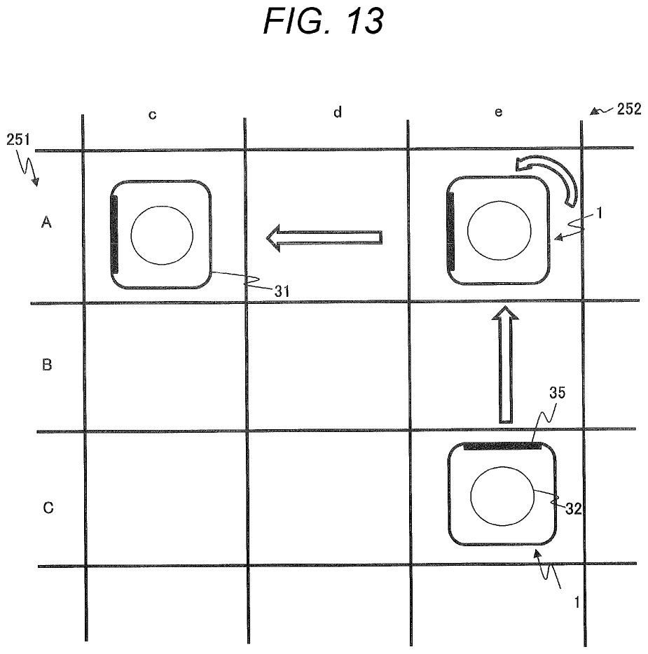

FIG. 13 is a plan view illustrating an example of a movement pattern of the transport apparatus 1 in which the straight traveling mode and the turning mode are combined. In the illustrated example, the transport apparatus 1 goes straight, then turns in units of 90°, and then goes straight.

The transport apparatus 1 travels straight from the area of the row number 251=“C” and the column number 252=“e” illustrated in FIG. 9 (hereinafter, referred to as C, e) to the position area (A, e), switches from the straight traveling mode to the turning mode, and turns 90° counterclockwise in the area (A, e).

When the shelf 7 is not loaded on the table 32, the transport apparatus 1 turns at the acceleration A (angular acceleration A) regardless of the previous movement mode, and turns the carriage 31 in the left direction in the drawing. On the other hand, when the shelf 7 is loaded on the table 32, since the previous movement mode is switched to the straight traveling mode and the next movement mode is switched to the turning mode, the transport apparatus 1 turns with the minimum acceleration C (angular acceleration C) to turn the carriage 31 in the left direction in the drawing.

Next, the transport apparatus 1 moves straight from the area (A, e) to the area (A, c). In this case, when the shelf 7 is not loaded on the table 32, the transport apparatus 1 moves straight at the maximum acceleration A and moves the carriage 31 in the left direction in the drawing.

On the other hand, when the shelf 7 is loaded on the table 32, since the previous movement mode is switched to the turning mode and the next movement mode is switched to the straight traveling mode, the transport apparatus 1 accelerates at the minimum acceleration C to move the carriage 31 in the left direction in the drawing.

As will be described later, when the movement mode is switched, friction between the auxiliary wheels 34 and the floor surface increases, and the load on the motor 38 at the start of movement increases. Therefore, when the previous movement mode and the next movement mode are switched and the shelf 7 is loaded, the transport apparatus 1 can reduce the driving force and suppress the consumption of the battery 39 by starting movement (or turning) at the minimum acceleration C. In addition, the load applied to the transport apparatus 1 and the floor surface can be reduced. When the shelf 7 is not loaded, the movement (or turning) is started at the maximum acceleration A, so that the time required for the movement can be shortened and the efficiency of the transport process can be improved.

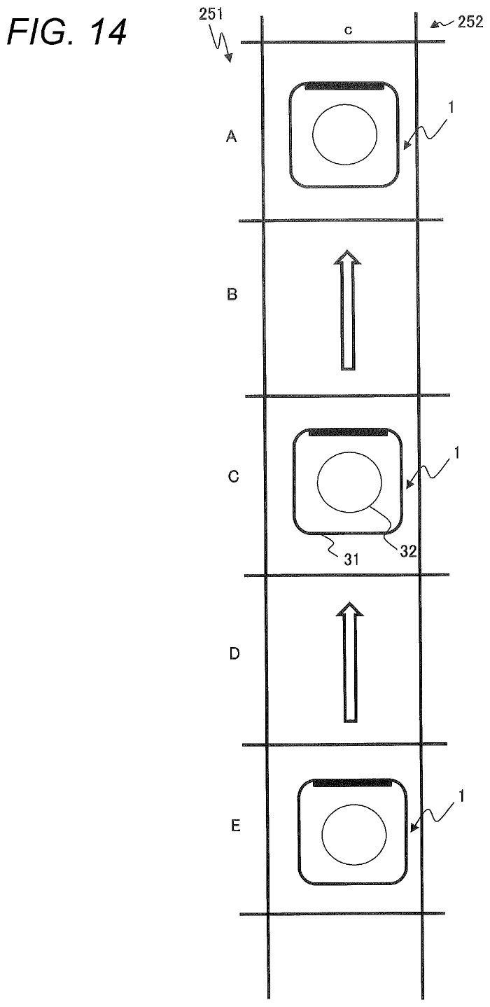

FIG. 14 is a plan view illustrating an example of a movement pattern of the transport apparatus 1 that repeats the straight traveling mode and the temporary stop. In the illustrated example, the transport apparatus 1 temporarily stops after traveling straight, and then travels straight again. As an example in which the transport apparatus 1 temporarily stops after moving straight and moves straight, for example, in a case where the other transport apparatus 1 passes through the area of the movement destination first, the transport apparatus 1 temporarily stops to wait for the other transport apparatus 1 to pass through the area. Alternatively, even when the transport apparatus 1 waits in line at the picking station ST, the transport apparatus 1 temporarily stops.

The transport apparatus 1 travels straight from the area (E, c) to the area (C, c) and then temporarily stops. Then, the vehicle travels straight from the area (C, c) to the area (A, c). In a case where the shelf 7 is not loaded on the table 32, the shelf 7 accelerates at the maximum acceleration A and moves between areas. In a case where the shelf 7 is loaded on the table 32, the shelf 7 accelerates at the intermediate acceleration B and moves between areas.

When the shelf 7 is not loaded, by starting the movement at the maximum acceleration A, the time required for the movement can be shortened and the efficiency of the transport process can be improved.

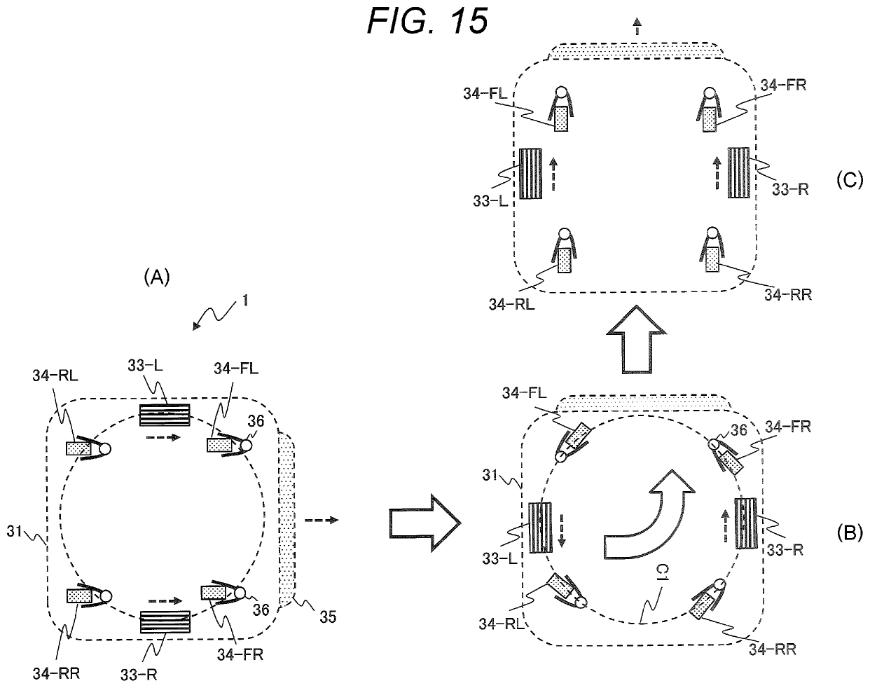

FIG. 15 is a perspective view from above illustrating an example of an auxiliary wheel when the auxiliary wheel is switched from the straight traveling mode to the straight traveling mode after turning counterclockwise by 90° in the turning mode. (A) to (C) of FIG. 15 illustrate the movement pattern of the transport apparatus 1 illustrated in FIG. 13 and the change in the movement of the auxiliary wheels 34.

First, in (A) of FIG. 15, the carriage 31 moves from the left side in the drawing to the right in the straight traveling mode. Each auxiliary wheel 34 is towed by the shaft 36 and rotates in the right direction in the drawing in parallel with the driving wheel 33.

In (B) of FIG. 15, the carriage 31 is temporarily stopped, and the control device 2 switches from the straight traveling mode to the turning mode to turn the carriage 31 counterclockwise by 90° in the drawing. When the turning of the carriage 31 is started, each auxiliary wheel 34 moves from the position of (A) toward the circle C1 of (B).

During the turning, the shaft 36 tows the auxiliary wheel 34 supported by the holder 37 along with the turning of the carriage 31, and the auxiliary wheel 34 rotates along the circle C1. (B) indicates a state in which the turning of the carriage 31 is completed, and each auxiliary wheel 34 stops along the circle C1.

In (C) of FIG. 15, the control device 2 switches from the turning mode to the straight traveling mode, and travels straight upward in the drawing. At the start of straight traveling of the carriage 31, each auxiliary wheel 34 moves from the circle C1 of (C) toward a position parallel to the driving wheel 33.

Friction between the auxiliary wheels 34 and the floor surface increases at the start of shifting from the straight traveling mode to the turning mode and at the time of shifting from the turning mode to the straight traveling mode.

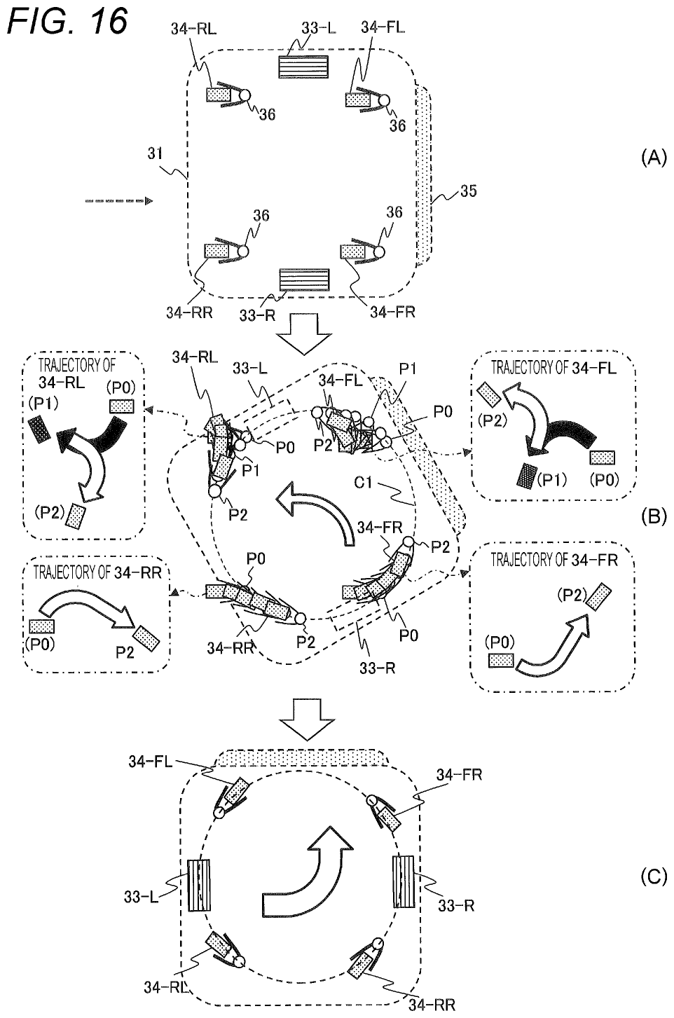

FIG. 16 is a perspective view from above illustrating an example of a trajectory of the auxiliary wheel when the auxiliary wheel turns counterclockwise by 90° in the turning mode from the straight traveling mode. (A) to (C) in the drawing illustrate a part of the trajectory of the auxiliary wheel 34 from (A) to (B) of FIG. 15.

In the state in which the straight traveling mode is completed, as illustrated in (A) of the drawing, each auxiliary wheel 34 stops at a position parallel to the driving wheel 33 along with the shaft 36. When the carriage 31 starts turning counterclockwise, each auxiliary wheel 34 starts to move toward the circle C1 along with the turning of the shaft 36 as illustrated in (B) of the drawing. In the drawing, P0, P1, and P2 indicate the positions of the shaft 36.

At the start of turning, the movement of each auxiliary wheel 34 is different, and the left auxiliary wheels 34-FL and 34-RL have larger friction with the floor surface than the right auxiliary wheels 34-FR and 34-RR.

First, the auxiliary wheel 34-FR serving as the front right wheel rotate on the floor surface while slightly turning counterclockwise of the shaft 36 from the position P0 in the drawing stopped in the straight traveling mode toward the circle C1, and gradually move to the position P2 along the circle C1. In this case, since the auxiliary wheel 34-FR only slightly turn around the shaft 36 while rotating, friction with the floor surface is small.

The auxiliary wheel 34-RR serving as the right rear wheel rotate on the floor surface while slightly turning clockwise of the shaft 36 from the position P0 at which the auxiliary wheels stop in the straight traveling mode toward the circle C1, and move to a position P2 along the circle C1. In this case, since the auxiliary wheel 34-RR only slightly turn around the shaft 36 while rotating, friction with the floor surface is small.

On the other hand, the auxiliary wheel 34-FL serving as the left front wheel turn clockwise on the shaft 36 while moving to the inside of the circle C1 so as to be pushed by the shaft 36 according to the turning along the circle C1 of the shaft 36 at the position P0 in the drawing stopped in the straight traveling mode, and go along the radial direction of the circle C1 at the position P1.

Further, the auxiliary wheel 34-FL turn clockwise about the shaft 36 while being towed by the shaft 36 from the position P1 according to the turning of the shaft 36 along the circle C1. When the shaft 36 turns on the circle C1 to the position P2, the auxiliary wheel 34-FL finally rotate on the circle C1.

As described above, the auxiliary wheel 34 FL turns clockwise about the shaft 36 while being pushed by the shaft 36 from the position P0 to the position P1, and are pushed toward the inside of the circle C1, and turns clockwise about the shaft 36 while being towed by the shaft 36 from the position P1 to the position P2. Therefore, the auxiliary wheel 34-FL turn on the floor surface almost without rotating, and friction with the floor surface becomes large.

The auxiliary wheel 34-RL serving as the left rear wheel turns about the shaft 36 in the clockwise direction while moving to the outside of the circle C1 so as to be pushed by the shaft 36 according to the turning along the circle C1 of the shaft 36 from the position P0 in the drawing stopped in the straight traveling mode. Then, the auxiliary wheel 34-RL turns clockwise about the shaft 36 while being towed by the shaft 36 toward the circle C1 at the position P1 after extending along the radial direction of the circle C1.

Further, the auxiliary wheel 34-RL rotates while turning clockwise about the shaft 36 while being towed by the shaft 36 from the position P1. When the shaft 36 turns about the circle C1 to the position P2, the auxiliary wheel 34-RL is along the circle C1.

As described above, the auxiliary wheel 34-RL is pushed by the shaft 36 from the position P0 to the vicinity of the position P1 and move to the outside of the circle C1 while turning clockwise around the shaft 36, and are towed by the shaft 36 from the vicinity of the position P1 to the position P2 and rotate while turning clockwise around the shaft 36. Therefore, the auxiliary wheel 34-RL turns on the floor surface and then rotate, and friction with the floor surface becomes large.

As described above, when the straight traveling mode is switched to the turning mode and the turning of the carriage 31 is started, the friction with the floor surfaces of the auxiliary wheels 34-FL and 34-RL in the turning direction increases. Therefore, when the carriage 31 is loaded with the shelf 7, the control device 2 switches to the minimum acceleration C (angular acceleration C), so that an increase in driving force according to an increase in friction can be suppressed, and the load of the motor 38 and the consumption of the battery 39 can be suppressed. In addition, the load applied to the transport apparatus 1 and the floor surface can be reduced.

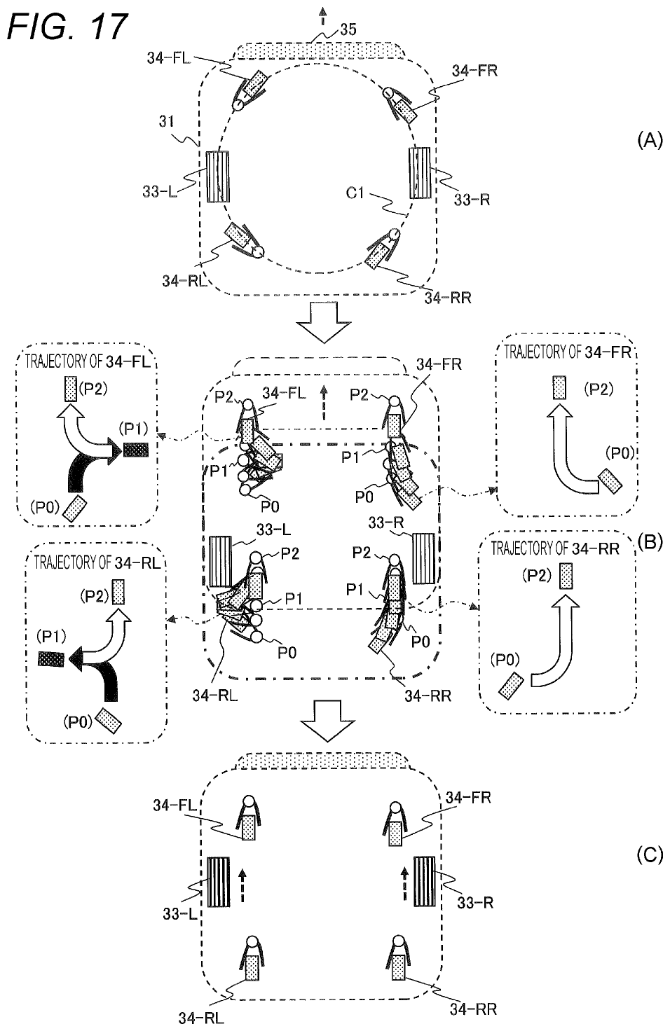

FIG. 17 is a perspective view from above illustrating an example of a trajectory of the auxiliary wheel when the auxiliary wheel goes straight from the turning mode in the straight traveling mode. (A) to (C) in the drawing illustrate a part of the trajectory of the auxiliary wheel 34 from (B) to (C) of FIG. 15.

In a state where the turning mode is completed, each auxiliary wheel 34 is stopped at a position along the circle C1 as illustrated in (A) of the drawing. When the carriage 31 starts to travel straight upward in the drawing, as illustrated in (B) in the drawing, each auxiliary wheel 34 is towed by the shaft 36 and starts to move away from the circle C1.

When the straight traveling is started, the movement of each auxiliary wheel 34 is different, and the left auxiliary wheels 34-FL and 34-RL have larger friction with the floor surface than the right auxiliary wheels 34-FR and 34-RR.

First, the auxiliary wheel 34-FR serving as the front right wheel is towed by the shaft 36 from the position P0 in the drawing stopped in the turning mode, and rotates on the floor surface while slightly turning clockwise of the shaft 36 toward the inside of the carriage 31. The auxiliary wheel 34-FR gradually becomes parallel to the driving wheel 33 while being towed by the shaft 36 and moving from the position P1 to the position P2. Since the auxiliary wheel 34-FR only slightly turns around the shaft 36 while rotating, friction with the floor surface is small.

The auxiliary wheel 34-RR serving as the right rear wheel rotates on the floor surface while slightly turning counterclockwise of the shaft 36 from the position P0 at which the auxiliary wheel is stopped in the straight traveling mode toward the outside of the carriage 31, and is towed by the shaft 36 to move to the positions P1 and P2. In this case, since the auxiliary wheel 34-RR only slightly turn around the shaft 36 while rotating, friction with the floor surface is small.

On the other hand, the auxiliary wheel 34-FL serving as the left front wheel turns counterclockwise on the shaft 36 while moving toward the inside of the carriage 31 so as to be pushed by the shaft 36 in accordance with the upward straight movement of the shaft 36 in the drawing at the position P0 stopped in the straight traveling mode, and are orthogonal to the straight traveling direction at the position P1.

Further, the auxiliary wheel 34-FL turns in the counterclockwise direction of the shaft 36 while being towed by the shaft 36 from the position P1 according to the straight movement of the shaft 36. Then, when the shaft 36 goes straight to the vicinity of the position P2, the auxiliary wheel 34-FL finally rotates upward in the drawing. At the position P2, the auxiliary wheel 34-FL rotates in parallel with the driving wheel 33.

As described above, the auxiliary wheel 34 FL turns counterclockwise about the shaft 36 while being pushed by the shaft 36 from the position P0 to the position P1, and are pushed toward the inside of the carriage 31, and turns counterclockwise about the shaft 36 while being towed by the shaft 36 from the position P1 to the position P2. Therefore, the auxiliary wheel 34-FL turn on the floor surface almost without rotating, and friction with the floor surface becomes large.

The auxiliary wheel 34-RL serving as the left rear wheel turns the shaft 36 counterclockwise while moving to the outside of the carriage 31 so as to be pushed by the shaft 36 in accordance with the straight movement of the shaft 36 upward in the drawing from the position P0 in the drawing stopped in the turning mode. Then, the auxiliary wheel 34-RL is substantially orthogonal to the straight traveling direction at the position P1, and then towed by the shaft 36 to turn the shaft 36 counterclockwise.

Further, the auxiliary wheel 34-RL rotates counterclockwise of the shaft 36 while being towed by the shaft 36 from the position P1, and gradually moves toward the inside of the carriage 31. When the shaft 36 goes straight to the position P2, the auxiliary wheel 34-RL rotates in parallel with the driving wheel 33.

As described above, the auxiliary wheel 34-RL is pushed by the shaft 36 from the position P0 to the vicinity of the position P1 and move to the outside of the carriage 31 while turning counterclockwise around the shaft 36, and are towed by the shaft 36 from the vicinity of the position P1 to the position P2 and rotate while turning counterclockwise around the shaft 36 so as to be toward the inside of the carriage 31. Therefore, the auxiliary wheel 34-RL starts to rotate after turning on the floor surface, and friction with the floor surface becomes large.

As described above, when the turning mode is switched to the straight traveling mode and the straight traveling of the carriage 31 is started, the friction with the floor surface of the turning auxiliary wheels 34-FL and 34-RL increases. For this reason, when the carriage 31 is loaded with the shelf 7, the control device 2 switches to the minimum acceleration C, so that an increase in driving force according to an increase in friction can be suppressed, a load of the motor 38 and the consumption of the battery 39 can be suppressed, and a load applied to the transport apparatus 1 and the floor surface can be reduced.

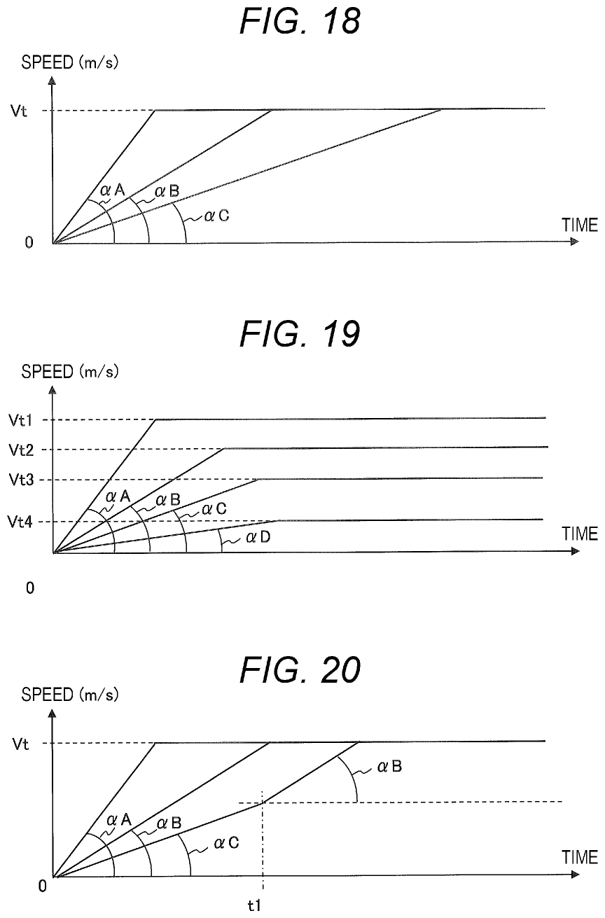

FIG. 18 is a graph illustrating an example of an acceleration switching pattern (acceleration condition) performed by the control device 2 and illustrating a relationship between speed and time. As illustrated in FIG. 12, when the shelf 7 is not loaded, the control device 2 accelerates the carriage 31 to a target speed Vt at the maximum acceleration A (αA in the drawing).

When the shelf 7 is loaded and there is no change from the previous movement mode, the control device 2 accelerates the carriage 31 to the target speed Vt at the intermediate acceleration B (αB in the drawing). Then, when the shelf 7 is loaded and the previous movement mode and the next movement mode are different, the control device 2 accelerates the carriage 31 to the target speed Vt with the minimum acceleration C (αC in the drawing). In the turning mode, the target speed Vt is replaced with a target angular speed.

As described above, the transport apparatus 1 of the present embodiment suppresses the acceleration at the time of starting the transport apparatus 1 after the movement mode is switched, so that the driving force at the time of starting can be reduced to suppress the load of the motor 38 and the consumption of the battery 39. In addition, the load applied to the transport apparatus 1 and the floor surface can be reduced.

In addition, the control device 2 of the transport apparatus 1 estimates the state of the floor surface for each area from the vibration (acceleration) of the travel track record data 45, and when the carrier starts or turns in an area where the magnitude of the vibration is equal to or greater than a predetermined threshold, even if the movement mode is not switched, the control device 2 can suppress the acceleration to the minimum acceleration C.

Further, when the control device 2 of the transport apparatus 1 acquires the floor information 240 from the warehouse control device 100 and starts or turns in an area where the floor state 243 of the floor satisfies a predetermined condition such as “small damage degree” or “medium damage degree”, even if the movement mode is not switched, the acceleration can be suppressed to the minimum acceleration C (acceleration condition).

The warehouse control device 100 may update the accumulated load 245 of the floor information 240 from the route of each transport apparatus 1, and may issue a command to switch the acceleration to the acceleration C when the transport apparatus 1 starts or turns in an area where the value of the accumulated load 245 exceeds a predetermined threshold. The command for switching the acceleration can be added to the route data 270.

### Second Embodiment

FIG. 19 illustrates a second embodiment, and is a graph illustrating an example of an acceleration switching pattern performed by the control device 2 and illustrating a relationship between speed and time. In the first embodiment, an example has been described in which the acceleration to the target speed (or the target angular speed) is switched depending on the presence or absence of the shelf 7 and the presence or absence of switching of the movement mode. In the present embodiment, an example of switching the target speed (target angular speed) in addition to the acceleration will be described. Other configurations are the same as those of the first embodiment.

When the shelf 7 is not loaded, the control device 2 accelerates the carriage 31 to a maximum target speed Vt1 at the maximum acceleration A (αA in the drawing).

When the shelf 7 is loaded and there is no change from the previous movement mode, the control device 2 accelerates the carriage 31 to a second target speed Vt2 at the second acceleration B (αB in the drawing). Then, when the shelf 7 is loaded and the previous movement mode and the next movement mode are different, the control device 2 accelerates the carriage 31 to the lower target speed Vt3 with a smaller acceleration C (αC in the drawing).

The acceleration B and the target speed Vt2 when the shelf 7 is loaded can be set as the first acceleration condition, the acceleration C and a target speed Vt3 when the previous movement mode and the next movement mode are different can be set as the second acceleration condition, and the acceleration A and the target speed Vt1 when the shelf 7 is not loaded can be set as the third acceleration condition.

Further, when the transport apparatus 1 accelerates on a damaged floor surface, the transport apparatus 1 can control the drive device 3 to accelerate under an acceleration condition including an acceleration smaller than the acceleration C or a target speed smaller than the target speed Vt3 instead of accelerating under the second acceleration condition (acceleration B, target speed Vt3). In the turning mode, the target speed is replaced with the target angular speed. The acceleration smaller than the acceleration C may be, for example, the acceleration D of αD in the drawing. The target speed smaller than the target speed Vt3 may be, for example, a target speed Vt4 in the drawing. The acceleration D is a minimum acceleration among the acceleration A, the acceleration B, the acceleration C, and the acceleration D, and may be referred to as “minimum acceleration D” in the following description.

As described above, in a case where the acceleration is large, the transport apparatus 1 can also set the target speed high to shorten the movement time of the carriage 31 and improve the transport efficiency, and in a case where the acceleration is small, the transport apparatus 1 can suppress an increase in the driving force due to the friction of the auxiliary wheel 34 and vibration in an area with a bad floor state. In addition, the load applied to the transport apparatus 1 and the floor surface can be reduced.

In addition to the above, the control device 2 can change the acceleration and the target speed according to the moving distance between the areas. For example, in FIG. 9, in a case where the carrier moves only to the adjacent area, the carrier may slowly accelerate and decelerate, or the target speed may be set low. On the other hand, when the moving distance between the areas is sufficiently long (when moving by predetermined distance or more, or by predetermined number of grids or more), the control device 2 can move at a higher speed.

Note that the subject that controls the acceleration and the target speed is not limited to the transport apparatus 1, and the warehouse control device 100 may determine the acceleration and the target speed, add the acceleration and the target speed to the route data, and issue a command.

The transport apparatus 1 may acquire the damaged state of the floor surface from the floor information 46 (or the floor information 240). Alternatively, the transport apparatus 1 may perform control under an acceleration condition including an acceleration smaller than the acceleration B or a target speed smaller than the target speed Vt instead of performing acceleration under the second acceleration condition as the damaged floor surface when the cumulative travel track record (accumulated load 245) exceeds a predetermined standard or the floor surface having unevenness is moved.

### Third Embodiment

FIG. 20 illustrates a second embodiment, and is a graph illustrating an example of an acceleration switching pattern performed by the control device 2 and illustrating a relationship between speed and time.

In the first embodiment, an example has been described in which the acceleration to the target speed (or the target angular speed) is switched depending on the presence or absence of the shelf 7 and the presence or absence of switching of the movement mode. In the present embodiment, an example will be described in which, after the movement (or turning) is started at the minimum acceleration C, the acceleration is increased to shorten the time to reach the target speed (target angular speed). Other configurations are the same as those of the first embodiment. Note that the maximum acceleration A and the intermediate acceleration B are similar to those in the first embodiment, and thus redundant description will be omitted.

When the shelf 7 is loaded and the straight traveling mode and the next movement mode are different, the transport apparatus 1 selects the minimum acceleration C (αC in the drawing) and drives the carriage 31. The transport apparatus 1 accelerates at the minimum acceleration C until the predetermined time t1 elapses, but increases the acceleration when the predetermined time t1 elapses. For example, the transport apparatus 1 can shorten the time for the carriage 31 to reach the target speed Vt by increasing the acceleration C to the intermediate acceleration B.

The time t1 is set to, for example, a time during which the shaft 36 passes through the position P2 at the minimum acceleration C as illustrated in FIGS. 16 and 17. As a result, the transport apparatus 1 can smoothly increase the speed of the carriage 31 while reducing the load applied to the transport apparatus 1 and the floor surface by increasing the acceleration B after the friction between the auxiliary wheel 34 and the floor surface decreases.

Note that the control may be performed such that, in a section in which the linear movement is started from the stop state and the load associated with the acceleration is large (determine moving distance, number of moving areas, time, etc.), the target speed is also reduced by slowly accelerating, and when the load associated with the acceleration decreases after passing through the section, the acceleration is increased to set the target speed high.

### CONCLUSIONS

As described above, the transport apparatus 1 of the first to third embodiments can be configured as follows.

(1) A transport apparatus (1) that conveys an article, the transport apparatus including a drive unit (drive device 3) that loads and moves the article; and a control unit (control device 2) that controls the drive unit (3), in which the transport apparatus (1) is movable in a plurality of movement modes including a movement mode (straight traveling mode) in which the transport apparatus (1) moves straight in a predetermined direction and a movement mode (turning mode) in which the transport apparatus (1) rotates to face different directions, and

the control unit (2) is configured to: control the drive unit (3) to accelerate under a first acceleration condition including a first acceleration (acceleration B) or a first target speed (Vt2) when the transport apparatus (1) loaded with the article moves in a same movement mode as a movement mode before stoppage among the plurality of movement modes with respect to an acceleration condition in a case where the transport apparatus (1) moves from a stopped state; and control the drive unit (3) to perform acceleration under a second acceleration condition including a second acceleration (acceleration C) smaller than the first acceleration (B) or a second target speed (Vt3) smaller than the first target speed (Vt2) when the transport apparatus moves in a movement mode different from a movement mode before stoppage among the plurality of movement modes.

With the above configuration, the transport apparatus 1 can reduce the load applied to the transport apparatus 1 and the floor surface by reducing the driving force at the time of starting by suppressing the acceleration at the time of starting the carriage 31 after the movement mode is switched.

(2) The transport apparatus (1) according to (1), in which the drive unit (3) includes: a driving wheel (33) connected to a power source (motor 38); and an auxiliary wheel (34) supporting the transport apparatus (1).

With the above configuration, in the transport apparatus 1, when the direction of the auxiliary wheel 34 is directed in a direction different from the moving direction when the carriage 31 is started after the movement mode is switched, the friction between the floor surface and the auxiliary wheel 34 increases, and a high load is applied to the auxiliary wheel 34 and the floor surface. In this case, the transport apparatus 1 can reduce the load applied to the transport apparatus 1 and the floor surface by reducing the driving force at the start by suppressing the acceleration.

(3) The transport apparatus (1) according to (1), in which the drive unit (3) is configured to: load a shelf (7) for storing the article, the control unit (2) is configured to: control the drive unit (3) to accelerate under a third acceleration condition including a third acceleration (acceleration A) larger than the first acceleration (B) or a third target speed (Vt1) larger than the first target speed (Vt2) regardless of a movement mode before stoppage with respect to an acceleration condition in a case where the transport apparatus (1) on which the article is not loaded moves from a stopped state.

With the above configuration, when the shelf 7 is not loaded, the transport apparatus 1 can move the carriage 31 with the maximum acceleration A regardless of the presence or absence of switching of the movement mode, and it is possible to effectively reduce the load applied to the transport apparatus 1 and the floor surface while considering the transport efficiency of the transport system.

(4) The transport apparatus (1) according to (1), in which the control unit (2) is configured to: with respect to an acceleration condition in a case where the transport apparatus (1) on which the article (7) is not loaded moves from a stopped state, control the drive unit (3) to perform acceleration under a third acceleration condition including a third acceleration (A) larger than the first acceleration (B) or a third target speed (Vt1) larger than the first target speed (Vt2) when the transport apparatus (1) moves in a same movement mode as a movement mode before stoppage among the plurality of movement modes, and control the drive unit (3) to perform acceleration under a fourth acceleration condition including a fourth acceleration (D) smaller than the third acceleration (A) or a fourth target speed (Vt4) smaller than the third target speed (Vt1) when the transport apparatus moves in a movement mode different from a movement mode before stoppage among the plurality of movement modes.

With the above configuration, it is possible to reduce the load applied to the transport apparatus 1 and the floor surface when it is preferable to switch the acceleration condition in different movement modes even when the transport apparatus 1 moves alone regardless of the loading of the shelf 7 depending on the situation of the transport apparatus 1, the floor surface, and the like.

(5) The transport apparatus (1) according to (1), in which the first target speed (Vt2) is set as the first acceleration condition, and the second target speed (Vt3) is set as the second acceleration condition, and the control unit (2) is configured to: control the drive unit (3) to achieve a target speed at an acceleration set in the acceleration condition.

With the above configuration, the transport apparatus 1 can suppress an increase in driving force due to friction of the auxiliary wheel 34 and reduce a load applied to the transport apparatus 1 and the floor surface by setting the target speed for acceleration to be low when the movement mode is switched.

(6) The transport apparatus (1) according to (1), in which the first acceleration (B) is set as the first acceleration condition, and the second acceleration (C) is set as the second acceleration condition, and the control unit (2) is configured to control the drive unit (3) to achieve a predetermined target speed.

With the above configuration, the transport apparatus 1 can suppress an increase in driving force due to friction of the auxiliary wheel 34 and reduce a load applied to the transport apparatus 1 and the floor surface by setting the acceleration at the time of acceleration low when the movement mode is switched.

(7) The transport apparatus (1) according to (1), in which the first acceleration condition is to accelerate at the first acceleration (B) to achieve the first target speed (Vt2), and the second acceleration condition is to accelerate at the second acceleration (C) to achieve the second target speed (Vt3).

With the above configuration, when the movement mode is switched, the transport apparatus 1 can suppress an increase in the driving force due to friction of the auxiliary wheel 34 and reduce the load applied to the transport apparatus 1 and the floor surface by setting both the acceleration at the time of acceleration and the target speed to be low.

(8) The transport apparatus (1) according to (1), in which the control unit (2) is configured to switch to a predetermined acceleration larger than the second acceleration (C) after a predetermined time (t1) from starting of the movement at the second acceleration (C).

With the above configuration, the transport apparatus 1 sets the predetermined time t1 to a time or the like during which the shaft 36 passes through the position P2 at the minimum acceleration C. As a result, the transport apparatus 1 can smoothly increase the speed of the carriage 31 while reducing the load applied to the transport apparatus 1 and the floor surface by increasing the acceleration B after the friction between the auxiliary wheel 34 and the floor surface decreases.

(9) The transport apparatus (1) according to (1), further including a storage unit (storage device 4) that stores information on a state of a floor surface on which the transport apparatus (1) moves, in which the control unit (2) is configured to determine an acceleration condition of the transport apparatus (1) based on the information (floor information 46) on the state of the floor surface.

With the above configuration, when the transport apparatus 1 starts to move in an area where the floor surface is damaged, the load on the floor surface can be reduced by changing the acceleration condition.

(10) The transport apparatus (1) according to (9), in which the information on the state of the floor surface includes information (floor information 46) on whether the floor surface is damaged, and the control unit (2) is configured to: with respect to an acceleration condition in a case where the transport apparatus (1) loaded with the article moves from a stopped state, in a case where the transport apparatus moves in a movement mode different from a movement mode before stoppage among the plurality of movement modes, control the drive unit (3) to accelerate under a fourth acceleration condition including an acceleration smaller than the second acceleration (C) or a target speed smaller than the second target speed (Vt3) instead of accelerating under the second acceleration condition when the transport apparatus accelerates on the damaged floor surface.

With the above configuration, when the transport apparatus 1 starts to move in an area where the floor surface is damaged, for example, the transport apparatus 1 can reduce the load applied to the floor surface by starting at the minimum acceleration D.

(11) The transport apparatus (1) according to (9), in which the information (46) on the state of the floor surface includes information on a cumulative travel track record (accumulated load 245) in which the transport apparatus (1) has traveled on the floor surface, and the control unit (2) is configured to: with respect to an acceleration condition in a case where the transport apparatus (1) on which the article is loaded moves from a stopped state, in a case where the transport apparatus moves in a movement mode different from a movement mode before stoppage among the plurality of movement modes, control the drive unit (3) to accelerate under an acceleration condition including an acceleration smaller than the second acceleration (C) or a target speed smaller than the second target speed (Vt3) instead of accelerating under the second acceleration condition when the cumulative travel track record (245) accelerates on the floor surface exceeding a predetermined standard.

With the above configuration, when the transport apparatus 1 starts to move by switching the movement mode in the area where the floor surface is damaged, for example, the transport apparatus 1 can reduce the load applied to the floor surface by starting at the minimum acceleration D.

(12) The transport apparatus (1) according to (9), in which the information (47) on the state of the floor surface includes information (243) on whether the floor surface is uneven, and the control unit (2) is configured to: with respect to an acceleration condition in a case where the transport apparatus (1) loaded with the article (7) moves from a stopped state, in a case where the transport apparatus moves in a movement mode different from a movement mode before stoppage among the plurality of movement modes, control the drive unit (3) to accelerate under an acceleration condition including an acceleration smaller than the second acceleration (C) or a target speed smaller than the second target speed (Vt3) instead of accelerating under the second acceleration condition when the transport apparatus accelerates on the uneven floor surface.

With the above configuration, when the transport apparatus 1 starts to move by switching the movement mode in the area where the unevenness is generated on the floor surface, for example, the transport apparatus 1 can reduce the load applied to the floor surface by starting at the minimum acceleration D.

(13) The transport apparatus (1) according to (1), further including a storage unit that stores transport object information (shelf information 230) including information (product weight 235) on a weight of an article loaded on the transport apparatus (1), in which the second acceleration (C) and the second target speed (Vt3) are set based on at least the transport object information (230).

With the above configuration, when the weight of the article loaded on the shelf 7 is heavy, the transport apparatus 1 can reduce the load applied to the floor surface by starting at a small acceleration C, for example.

The present invention is not limited to the embodiments described above, but includes various modifications. For example, the embodiments have been described in detail in order to help with understanding on the invention, but the invention is not limited to the one equipped with all the configurations. In addition, some of the configurations of a certain embodiment may be replaced with the one of the other embodiment. In addition, the configuration of the other embodiment may be added to the configuration of a certain embodiment. In addition, some of the configurations of each embodiment may be applied even when the other configurations are added, deleted, or replaced individually or in combination.

In addition, some or all of the configurations, the functions, the processing units, and processing devices may be realized in hardware by designing with an integrated circuit for example. In addition, the configurations and the functions may be realized in software by analyzing and executing a program which realizes the functions of a processor. Information such as a program, a table, and a file for achieving each function can be stored in a recording device such as a memory, a hard disk, or a solid-state drive (SSD), or a recording medium such as an integrated circuit (IC) card, a secure digital (SD) card, or a digital versatile disc (DVD).

In addition, only control lines and information lines considered to be necessary for explanation are illustrated, but not all the control lines and the information lines for a

manufacture are illustrated. In practice, almost all the configurations may be considered to be connected to each other.

1. A transport apparatus that conveys an article, the transport apparatus comprising:
a drive unit that loads and moves the article; and
a control unit that controls the drive unit, wherein
the transport apparatus is movable in a plurality of movement modes including a movement mode in which the transport apparatus moves straight in a predetermined direction and a movement mode in which the transport apparatus rotates to face different directions, and
the control unit is configured to:
control the drive unit to accelerate under a first acceleration condition including a first acceleration or a first target speed when the transport apparatus loaded with the article moves in a same movement mode as a movement mode before stoppage among the plurality of movement modes with respect to an acceleration condition in a case where the transport apparatus moves from a stopped state; and
control the drive unit to perform acceleration under a second acceleration condition including a second acceleration smaller than the first acceleration or a second target speed smaller than the first target speed when the transport apparatus moves in a movement mode different from a movement mode before stoppage among the plurality of movement modes.

2. The transport apparatus according to claim 1, wherein
the drive unit includes:
a driving wheel connected to a power source; and an auxiliary wheel supporting the transport apparatus.

3. The transport apparatus according to claim 1, wherein
the drive unit is configured to
load a shelf for storing the article, and
the control unit is configured to
control the drive unit to accelerate under a third acceleration condition including a third acceleration larger than the first acceleration or a third target speed larger than the first target speed regardless of a movement mode before stoppage with respect to an acceleration condition in a case where the transport apparatus on which the article is not loaded moves from a stopped state.

4. The transport apparatus according to claim 1, wherein
the control unit is configured to:
with respect to an acceleration condition in a case where the transport apparatus on which the article is not loaded moves from a stopped state,
control the drive unit to perform acceleration under a third acceleration condition including a third acceleration larger than the first acceleration or a third target speed larger than the first target speed when the transport apparatus moves in a same movement mode as a movement mode before stoppage among the plurality of movement modes; and
control the drive unit to perform acceleration under a fourth acceleration condition including a fourth acceleration smaller than the third acceleration or a fourth target speed smaller than the third target speed when the transport apparatus moves in a movement mode different from a movement mode before stoppage among the plurality of movement modes.

5. The transport apparatus according to claim 1, wherein
the first target speed is set as the first acceleration condition, and the second target speed is set as the second acceleration condition, and
the control unit is configured to:
control the drive unit to achieve a target speed at an acceleration set in the acceleration condition.

6. The transport apparatus according to claim 1, wherein
the first acceleration is set as the first acceleration condition, and the second acceleration is set as the second acceleration condition, and
the control unit is configured to control the drive unit to achieve a predetermined target speed.

7. The transport apparatus according to claim 1, wherein
the first acceleration condition is to accelerate at the first acceleration to achieve the first target speed, and
the second acceleration condition is to accelerate at the second acceleration to achieve the second target speed.

8. The transport apparatus according to claim 1, wherein
the control unit is configured to
switch to a predetermined acceleration larger than the second acceleration after a predetermined time from starting of the movement at the second acceleration.

9. The transport apparatus according to claim 1, further comprising
a storage unit that stores information on a state of a floor surface on which the transport apparatus moves, wherein
the control unit is configured to
determine an acceleration condition of the transport apparatus based on the information on the state of the floor surface.

10. The transport apparatus according to claim 9, wherein
the information on the state of the floor surface includes information on whether the floor surface is damaged, and
the control unit is configured to:
with respect to an acceleration condition in a case where the transport apparatus loaded with the article moves from a stopped state,
in a case where the transport apparatus moves in a movement mode different from a movement mode before stoppage among the plurality of movement modes,
control the drive unit to accelerate under an acceleration condition including an acceleration smaller than the second acceleration or a target speed smaller than the second target speed instead of accelerating under the second acceleration condition when the transport apparatus accelerates on the damaged floor surface.

11. The transport apparatus according to claim 9, wherein
the information on the state of the floor surface includes information on a cumulative travel track record in which the transport apparatus has traveled on the floor surface, and
the control unit is configured to:
with respect to an acceleration condition in a case where the transport apparatus on which the article is loaded moves from a stopped state,
in a case where the transport apparatus moves in a movement mode different from a movement mode before stoppage among the plurality of movement modes,
control the drive unit to accelerate under an acceleration condition including an acceleration smaller than the second acceleration or a target speed smaller than the second target speed instead of accelerating under the second acceleration condition when the cumulative travel track record indicates acceleration on the floor surface exceeding a predetermined standard.

12. The transport apparatus according to claim 9, wherein
the information on the state of the floor surface includes information on whether the floor surface is uneven, and
the control unit is configured to:
with respect to an acceleration condition in a case where the transport apparatus loaded with the article moves from a stopped state,
in a case where the transport apparatus moves in a movement mode different from a movement mode before stoppage among the plurality of movement modes,
control the drive unit to accelerate under an acceleration condition including an acceleration smaller than the second acceleration or a target speed smaller than the second target speed instead of accelerating under the second acceleration condition when the transport apparatus is accelerated on the uneven floor surface.

13. The transport apparatus according to claim 1, further comprising
a storage unit that stores transport object information including information on a weight of an article loaded on the transport apparatus, wherein
the second acceleration and the second target speed are set based on at least the transport object information.

14. A transport system comprising:
a transport apparatus that conveys an article; and
a control device that controls traveling of the transport apparatus, wherein
the transport apparatus is movable in a plurality of movement modes including a movement mode in which the transport apparatus moves straight in a predetermined direction and a movement mode in which the transport apparatus rotates to face different directions, and
the control device is configured to:
control the transport apparatus to accelerate under a first acceleration condition including a first acceleration or a first target speed when the transport apparatus loaded with the article moves in a same movement mode as a movement mode before stoppage among the plurality of movement modes with respect to an acceleration condition in a case where the transport apparatus moves from a stopped state; and
control the transport apparatus to perform acceleration under a second acceleration condition including a second acceleration smaller than the first acceleration or a second target speed smaller than the first target speed when the transport apparatus moves in a movement mode different from a movement mode before stoppage among the plurality of movement modes.

15. A controls method for a transport apparatus, the method comprising:
determining, when the transport apparatus moves from a stopped state, whether the transport apparatus moves in a same movement mode as a movement mode before stoppage among a plurality of movement modes including a movement mode in which the transport apparatus moves straight in a predetermined direction and a movement mode in which the transport apparatus rotationally moves so as to face different directions; and
controlling the transport apparatus to accelerate under a first acceleration condition including a first acceleration or a first target speed when the transport apparatus moves in a same movement mode as a movement mode before stoppage among the plurality of movement modes, and controlling the transport apparatus to accelerate under a second acceleration condition including a second acceleration smaller than the first acceleration or a second target speed smaller than the first target speed when the transport apparatus moves in a movement mode different from a movement mode before stoppage among the plurality of movement modes.
